(19) United States
(12) Patent Application Publication
(10) Pub. No.: US 2023/0035726 A1
(43) Pub. Date: Feb. 2, 2023

(54) FOLDABLE PITFALL BEDBUG TRAP

(71) Applicant: BEDBUG CENTRAL, LLC, Hamilton, NJ (US)

(72) Inventor: JEFFREY G. WHITE, Hamilton, NJ (US)

(73) Assignee: Bedbug Central, LLC, Hamilton, NJ (US)

(21) Appl. No.: 17/962,643

(22) Filed: Oct. 10, 2022

Related U.S. Application Data
(63) Continuation of application No. 17/068,789, filed on Oct. 12, 2020, now abandoned.

(51) Int. Cl. A01M 1/14; A01M 1/10; B31B 50/74; B31B 50/26; B31B 50/62

(52) U.S. Cl. CPC A01M 1/14; A01M 1/103; B31B 50/742; B31B 50/26; B31B 50/624; A01M 2200/011

(57) ABSTRACT

A trap for certain insect pests may be configured to be particularly suitable for bedbugs and take the form of a foldable pitfall bedbug trap. The pitfall trap walls extend vertically upwardly at an angle and are sufficiently rough to permit bedbugs to climb to an upper edge of the trap, whereas the inner surfaces of the pitfall trap walls have been treated with a smooth material, such as being laminated, causing bedbugs at the upper edge to fall upon initiating contact with the inner pitfall walls and their smooth characteristics. The resultant foldable pitfall bedbug trap is relatively inexpensive to produce and easily user-deployable.

### FIELD

This disclosure relates to trapping devices for certain crawling insect pests and, in particular, to pitfall traps suitable for bedbugs.

### BACKGROUND

Glueboard-style traps generally designed for attracting and trapping cockroaches and thus may not be suitable for application to other crawling insect pests, namely bedbugs. Accordingly, such glueboard traps suffer from various drawbacks and disadvantages, especially with regard to trapping bedbugs, and further such traps may not always be optimal even at trapping other crawling insect pests, such as cockroaches. In particular, glueboard traps often permit the bedbug or other crawling insect pest to approach the glueboard surface in such a manner that, upon partial or tentative exploratory contact with such glueboard surface, the bedbug is able to retreat or back away from the glueboard without being trapped thereon.

One approach to trapping bedbugs in particular makes use of relatively rigid plastic molded or formed to include rigid walls and a vertical receiving area surrounded by such vertical walls. These traps thus create a pit into which bedbugs may fall, and the traps are designed so that bedbugs are unable to escape from such pit. One of the drawbacks of these types of bedbug traps is they may be more expensive to produce, more complicated to stock and ship, and thus may be more cost prohibitive to customers and other potential users.

Accordingly, it would be desirable to have a trap for bedbugs and other crawling insect pests which does not suffer from the aforementioned drawbacks and disadvantages.

### SUMMARY

The claimed invention provides a flat, single-piece, easy-to-assemble pest control device made of cardboard or other lightweight and inexpensive material, which has an adhesive base as its interior floor, and foldable side panels which attach to each other through a tab and slot or other means of attachment, to form side walls and enclose an interior chamber with an open top, which forms a pit to detain insects, spiders, and other pests. As indicated above, the upper surface of the central base portion, which forms the interior floor of the invention, will have an adhesive or otherwise tacky layer, which can be covered with a removable liner prior to, or when not in, use.

The underside of each side panel—which form the outer walls when folded upward for deployment of the bug trap device—is comprised of a substantially rough surface, facilitating traction of a bug climbing or otherwise contacting the wall and moving upward before terminating at the upper edge.

The upper surface of each of the side panels—which form the interior side walls when folded upward in the deployed iteration of the bug trap—is made from, or coated with, a substantially frictionless material. This causes the bugs to lose traction and fall on to the glue below, and once in the pit of the trap, if by a sidewall, the smooth surface reduces the ability of the bugs from removing themselves from the glue.

The possible combinations of the embodiments of the present invention offer benefits over previous pest control lures and traps, specifically that insects, arachnids, and myriapods, and more specifically bedbugs and roaches, will engage with and climb up the outer wall surfaces and, once it reaches the upper edge, be unable to get traction on the smooth or slick interior wall, which extends downward from the upper edge toward the base or floor of the trap, causing the insect pest to fall onto the adhesive of the base. The surface may be laminated cardboard, or coated with a polymeric material or plastic.

In one embodiment of the present invention, the side panels, when folded upward in the deployed bug trap, can be folded at an angle ranging from 75 degrees relative to the adhesive base to 90 degrees, creating an easy to assemble open, unlidded box form.

As such, in one of the preferred embodiments, in its deployed form, the side panels can be folded upward and inward toward the interior of the device, such that the upper edges of the side panels terminate in a position disposed over the adhesive surface, increasing the likelihood that pests stalled or perched atop such upper edge may fall onto the adhesive base portion and become arrested thereby. There are multiple variations of this preferred embodiment, which can involve folding the walls at varying grades inward, and the angle formed by the interior of the side walls and the floor may be in the range of 30 degrees to 90 degrees.

One embodiment of the present invention comprises a structure wholly or partially made of cardboard, which material bedbugs find more hospitable, or for which bedbugs exhibit a more natural affinity for, than other materials.

In a preferred embodiment, the adhesive composition or coating on or atop the floor of the present invention may include a pest attractant or other lure.

### BRIEF DESCRIPTION OF THE DRAWINGS

The implementations described and disclosed herein will be better understood with reference to the drawings, in which:

FIG. 1 is a top plan view of a foldable, pitfall bedbug trap in its undeployed configuration, according to one possible implementation;

FIG. 2 is a perspective view of the foldable, pitfall bedbug trap of FIG. 1, in a deployed configuration;

FIG. 3 is a side elevation view of the trap of FIG. 2; and

FIG. 4 is a top plan view of the trap of FIGS. 1-3.

### DETAILED DESCRIPTION

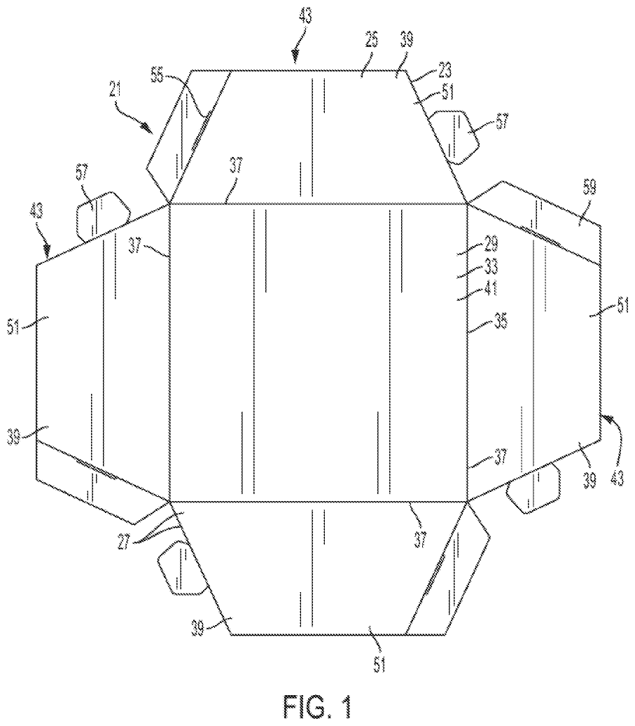

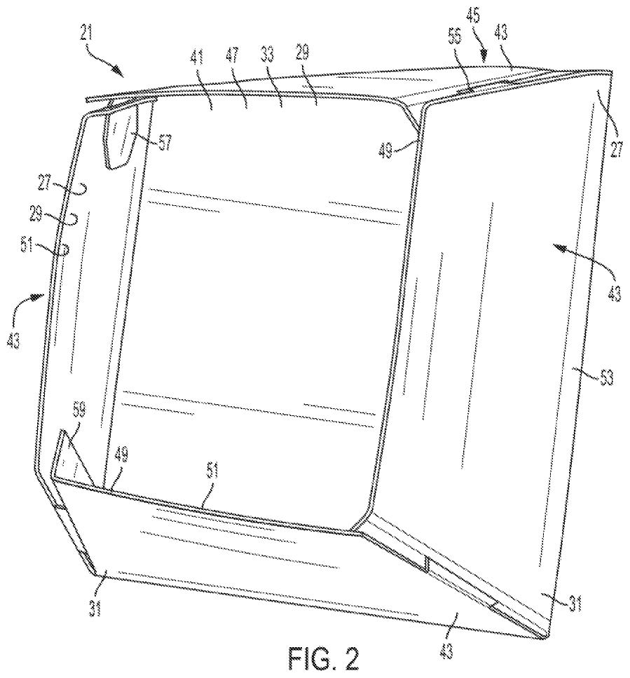

Referring now to the drawings, and in particular to FIGS. 1-4 therein, a user-deployable apparatus for attracting and apprehending insect pests, such as arachnids or myriapods, is shown in this implementation as a foldable, pitfall bedbug trap 21. Trap 21 may be user-deployable and thus assume an undeployed configuration 23 (FIG. 1), in the form of a blank 25 formed of paperboard, cardboard, or other foldable material, whether polymeric, resinous, fibrous, and the like. In this implementation, blank 25 has been cut from only a single sheet of either paperboard or cardboard and has opposite, substantially planar surfaces 27. In the orientations shown in the drawings, substantially planar surfaces 27 comprise a top surface 29 (FIG. 1) and opposite bottom surface 31, as best seen in FIGS. 2-4. Blank 25 may be cut or otherwise configured so that defined within its periphery are a base panel which extends to a base perimeter 35 having four perimeter edges 37 in this implementation.

A plurality of side panels 39 are foldably connected to corresponding ones of the perimeter edges 37 of base panel 33. The foldability of side panels 39 relative to base panel 33 may be enhanced by suitable score lines or other finishing of the paperboard, cardboard, or other planar material from which blank 25 may be formed herein. As best seen in FIGS. 2-4, the blank 25 herein has its opposite planar surfaces 27 relatively proximate to each other over all of the areas of panels 33, 39, and in this way, blank 25 and the corresponding trap 21 have a substantially planar profile in the undeployed configuration 23. Top surface 29 over the base panel 33 is provided with a suitable adhesive layer 41.

Side panels 39 extend to terminate in opposite side panel edges to define respective, side panel areas, such side panel areas forming pitfall trap walls 43 when trap 21 is user deployed into a deployed configuration 45. As best seen in FIGS. 2-4, side panels 39 and their corresponding side panel edges are dimensioned to form a pitfall enclosure 47 surrounded by pitfall trap walls 43 when side panels 39 are user deployed by folding upwardly relative to top surface 29 of base panel 33 in the orientation shown in FIG. 1.

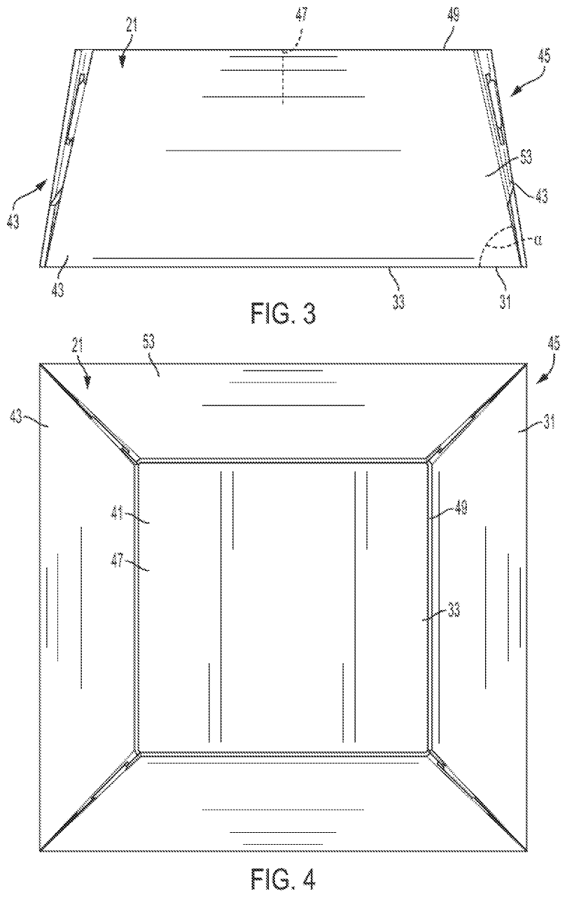

Pitfall enclosure 47, when formed by suitable deployment of trap 21, has a pitfall upper edge 49, which upper edge 49 is defined by outer edges of side panels 39, and which upper edge 49 forms a circumference completely around base panel 33, but inwardly therefrom by virtue of a slope imparted to walls 43 in this implementation. More specifically, walls 43 may extend inwardly from base perimeter edges 37 and extend upwardly to pitfall upper edge 49 at a predetermined deployed angle α (FIG. 3) ranging from between 30 degrees to about 90 degrees relative to base panel 33, and preferably from about 60 degrees to about 75 degrees. In the case of a 90 degrees deployed angle upper edge 49 would be substantial coincident with base perimeter 35, whereas at deployed angles less than 90 degrees, the pitfall trap walls extend over the adhesive layer on base panel 33.

Pitfall trap walls 43, being formed of planar material, comprise opposite inner and outer pitfall walls 51, 53, respectively. As such, inner pitfall walls 51 correspond to top surface 29 over side panels 39 when trap 21 is in the undeployed configuration. Likewise, bottom surface 31 corresponds to outer pitfall walls 53.

Outer pitfall walls 53 are selected so that they have a roughness which permits bedbugs to crawl from the bottom of trap 21 when deployed, such as base panel 33, up outer pitfall walls 53 to upper edge 49. In one possible implementation, outer pitfall walls are cardboard or paperboard which has been used to create blank 25. In other possible implementations, outer pitfall wall 53 may have its substrate treated, roughened, or otherwise provided with features to enable bedbugs to crawl up the pitfall wall 53. Inner pitfall walls 51 have been treated or otherwise provided with a polymeric coating disposed thereon over substantially all the side panel areas. The polymeric coating of inner peripheral walls have been selected to have a smoothness so as bedbugs to fall from upper edge 49 upon attempting to contact the adjacent areas of inner pitfall walls 51, which have been equipped with such smooth, polymeric coating. In this way, bedbugs fall into pitfall enclosure 47 and get trapped on adhesive layer 41.

It will be appreciated that the smooth characteristics of inner pitfall walls 51 may be accomplished through a variety of means, including not only spraying or sputtering techniques, but likewise laminating techniques or applying suitable silicon, or other laminate in a film or other flexible layer to surfaces of cardboard or paperboard.

Likewise, it will be appreciated that the base panel 33 is shown in this implementation as quadrilateral, particularly square, other polygonal shapes having at least three sides, and blanks corresponding to such alternate polygonal shapes, are within the scope and spirit of the present invention.

Blank 25 has been equipped with suitable features so that upon folding of side panels 39 relative to base panel 33, the resultant pitfall trap walls 43 may be held at a desired deployed angle alpha, in this case such fixing means comprising latches 57 user-insertable into slots or keys 55, the latch-end-slot arrangement being disposed on opposing side edges of adjacent side panels 59 when in deployed configuration 45. Alternately, adhesive may be applied to surfaces of flaps 59 and selectively pressed against corresponding regions of adjacent side panels to hold side panels 39 in place to form pitfall trap walls 43.

Adhesive layer 41, in this implementation, extends substantially to base perimeter 35 and substantially covers top surface 29 of base panel 33. Depending on the location of upper edge 49 relative to the corresponding location on base panel 33, it is possible for adhesive layer 41 to be reduced to the likely locations of falling bedbugs from upper edge 49.

In one suitable use, bedbug trap 21 may be mass-produced from larger stock of cardboard or paperboard. Application of laminate or smooth polymeric treatment of one of the surfaces of blank 25 may be accomplished either subsequent to formation of blank 25 or as part of treatment of larger rolls or sheets of paperboard, cardboard, or other fibrous or polymeric material from which blanks 25 are being formed. In view of the foregoing, manufacture of a pitfall trap particularly suitable for bedbugs may be rendered more cost effective than rigid plastic bedbug traps of the prior art.

From a user perspective, one or more traps 21 may be acquired in the form of blanks 25, which are more efficiently packaged. The user may deploy trap 21 with relative ease, using key and slot configuration shown without requiring additional tools and without use of adhesive.

The resultant deployed configuration 45, by use of upwardly slopping pitfall trap walls 43 and corresponding upper edge 49, has the advantage of causing bedbugs to fall onto adhesive layer 41, thus eliminating the potential for bedbugs or other crawling insects to back away or otherwise disengage from partial interaction with adhesive layer 41 which would otherwise be caused by such bedbugs approaching adhesive layer 41 from an adjacent location not raised relative to such adhesive layer. Though the dimensions of blank 25 and the corresponding panels 33, 39, may be varied for any number of applications, and while the use of trap 21 for insect pests other than bedbugs may likewise require different sizes and dimensions, one suitable implementation has base perimeter edges at about 114 mm and the side panels 39 having a dimension of about 37 mm between inner side panel edges and outer side panel edges, corresponding to upper edge 49. In another implementation, trap 21 may be sized more compactly to have base perimeter edges extending about 76 mm and side panels 39 extending from such base perimeter edges by about 25 mm to outer side panel edges corresponding to upper edge 49.

These and other variations are likewise subsumed within the present disclosure, which shall not be considered as limited by the implementations described herein, but shall cover variations within the spirit and scope of the appended claims.

What is claimed is:

1. A foldable pitfall bedbug trap, comprising:
a blank cut from only a single sheet of at least one of cardboard and paperboard, the blank having opposite, substantially planar surfaces, the planar surfaces orientable to define top and bottom surfaces, the blank further having defined therein a base panel and side panels, the panels having respective areas, the planar surfaces extending proximate each other over all of the areas of the panels to define a substantially planar profile for the blank;
wherein the top surface of the base panel comprises an adhesive layer;
wherein the base panel extends to a base perimeter having at least three perimeter edges, and the side panels have respective side panel edges, the side panel edges spaced from each other to define respective, side panel areas corresponding to pitfall trap walls when the trap is in a deployed configuration, the side panel edges comprising opposite inner and outer edges, and side edges extending between the inner and outer edges;
wherein the inner edges of the side panels are foldably connected to corresponding ones of the base perimeter edges;
wherein the side panel edges are dimensioned to form a pitfall enclosure surrounded by the walls when the side panels are folded relative to the top surface of the base panel into the deployed configuration;
wherein the pitfall enclosure has a pitfall upper edge defined by the outer edges of the side panels, the walls extending inwardly from the base perimeter edges to the pitfall upper edge at a predetermined deployed angle ranging from about 90 degrees to about 75 degrees relative to the base panel, the walls of the pitfall enclosure comprising opposite inner and outer pitfall walls, the top surface of the side panels corresponding to the inner pitfall walls and the bottom surface of the side panels corresponding to the outer pitfall walls;
wherein, when at the deployed angle, the outer pitfall wall has a roughness selected to permit the bedbugs to crawl to the upper edge;
wherein, when at the deployed angle, the inner pitfall walls have a polymeric coating disposed thereon over substantially all of the side panel areas, wherein the polymeric coating of the inner wall is selected to have a smoothness to cause the bedbugs to fall from the upper edge upon attempted contact with the inner pitfall wall;
whereby the bedbugs fall into the pitfall enclosure and get trapped on the adhesive layer.

2. The bedbug trap of claim 1, wherein the base panel has four substantially straight and contiguous perimeter edges meeting at opposite right angles, to define a quadrilateral.

3. The bedbug trap of claim 1, wherein the outer edge of each side panel is shorter in length than the opposite inner edge.

4. The bedbug trap of claim 1, wherein the side panels are fixed in their predetermined folded position by means of attachment to one or more adjacent side panels.

5. The bedbug trap of claim 1, wherein the polymeric coating of the inner pitfall walls comprises at least one layer of laminate.

6. A user-deployable apparatus for apprehending crawling pests selected from the group consisting of insects, arachnids, or myriapods, the apparatus comprising a plurality of contiguous flat panels of fibrous material, the panels including a base having an upper surface selectively covered with adhesive and a plurality of side panels foldably connected to the base at seams for providing side walls of the apparatus, with each side panel having a base end connected to the base at a respective one of the seams and a free end opposite the base end, the side panel having a flange and a recess capable of receiving the flange of an adjacent one of the side panels to secure the panels relative to each other in a deployed configuration.

7. The apparatus of claim 6, wherein each of the side panels has a length that is shorter at the free end than at the base end to orient the side walls inwardly, the side panels forming an internal chamber with an open top when the side panels are secured in the deployed configuration.

8. The apparatus of claim 6, wherein the angle formed by each side panel and the planar base ranges from 30 degrees to 90 degrees.

9. The apparatus of claim 6, wherein the side panels have opposite, planar inner and outer surfaces, the inner surfaces comprised of a substantially frictionless material, and the outer surfaces having a texture preselected to be suitable for the crawling pests to advance up the outer surfaces when the apparatus is in the deployed configuration.

10. The apparatus of claim 9, wherein one of the adhesive and the surface of the side panel contains an active ingredient acting as a lure for the crawling pests.

11. The apparatus of claim 6, wherein the adhesive consists of a non-drying adhesive.

12. The apparatus of claim 6, wherein the base comprises a central planar base, and wherein the plurality of side panels and the base are constructed from one or more layers of at least one of cardboard, paperboard, and other cellulose-derived material.

13. The apparatus of claim 6, wherein the seams of the base comprise four substantially straight and contiguous foldable edges which meet at opposite right angles, to define a quadrilateral.

14. The apparatus of claim 6, wherein the inner surfaces of the side panels have at least one of a layer of laminate and polymeric coating disposed thereon.

15. A device configured to capture crawling pests selected from the group consisting of insects, arachnids, and myriapods, the device formed by folding along designated seams a single, substantially flat piece of at least one of cardboard and paperboard, the device comprising:
an innermost base section having a surface with tacky material disposed thereon as at least one of a layer and coating thereof; and
a plurality of sections extending radially outward from the base section and separated therefrom by interior foldable edges, the sections having respective upper surfaces and undersides, the upper surfaces configured to be smooth and flat, the undersides having a texture coarser than the upper surfaces, the texture selected to provide a measure of friction relative to external elements;
wherein the sections include:
front and rear sections extending from the front and rear interior foldable edges of the base section respectively, and each terminating at a distal edge, and
at least one side section extending laterally from the base section, and terminating at a distal edge;
whereby the sections, when folded to a predetermined position, create a semi-enclosed interior space and an aperture positioned to be accessible to the pests, with the base section defining the floor of the interior space, the front and rear sections defining the front and rear walls of the interior space, and at least one side section forming one or more side walls of the interior space.

16. The device of claim 15, wherein the base section has four substantially straight and contiguous interior foldable edges meeting at opposite right angles, to define a quadrilateral.

17. The device of claim 15, wherein the angle formed by folding each of the side, rear, and one or more side sections about the interior foldable edge connecting each such suction to the base section ranges from 30 degrees to 90 degrees.

18. The device of claim 15, further comprising two parallel side sections, wherein the front and rear sections and each of the two side sections extend inward toward the center of the base section when folded, creating a perimeter for the aperture smaller in size than an outer perimeter of the base section.

19. The device of claim 15, wherein the interior foldable edges separating the side, rear, and one or more side sections from the base section have a first length; and the distal edges of each of the side, rear, and one or more side sections have a second length which is shorter than the first length.

20. The device of claim 15, wherein the front, rear, and side sections are folded at each of such section's interior foldable edge and fixed in an upright position by affixing each section to one more adjacent sections.
